(19) United States
(12) Patent Application Publication
(10) Pub. No.: US 2005/0091134 A1
(43) Pub. Date: Apr. 28, 2005

(54) Method and medium for financial disclosure

(76) Inventor: Michael T. Rossides, Scottsdale, AZ (US)

Correspondence Address: MICHAEL T. ROSSIDES, 11167 E. MIRASOL CIRCLE, SCOTTSDALE, AZ, 85255, US

(21) Appl. No.: 10/693,381

(22) Filed: Oct. 23, 2003

(51) Int. Cl. G06F 17/60

(52) U.S. Cl. 705/35

(57) ABSTRACT

We disclose a betting method and medium that identify a company's “insiders” and enable these insiders to make and transact publicly displayed, non-anonymous bet offers about subjects that are important to the company's financial condition and/or prospects. The invention enables users to make bets about a variety of well-known financial measures and events, such as earnings, return on investment, bankruptcy, and so forth. The invention enables users to make bets about how well an investment company will perform compared to a benchmark or an alternative investment. The invention provides for displaying bet offers and agreements by identified insiders, thereby providing a new kind of financial disclosure.

### CROSS REFERENCES TO RELATED APPLICATIONS

This application was preceded by Disclosure Documents 531,658, filed May 19, 2003, 534,701, filed Jul. 11, 2003 and a yet-to-be-numbered document, filed Oct. 7, 2003.

This application was preceded by provisional patent application 60/376,078, filed Apr. 25, 2002.

This application was preceded by PCT application US03/13011, filed Apr. 24, 2003, which hereby enters the National Stage of the PCT.

This application incorporates by reference provisional patent application 60/471,539, filed May 19, 2003.

This application incorporates by reference U.S. patent application Ser. No. 10/646,017, filed Aug. 22, 2003.

This application incorporates by reference U.S. Pat. Nos. 5,575,474 and 6,443,841.

### STATEMENT REGARDING FEERALLY SPONSORED RESEARCH

Not applicable.

### BACKGROUND

1. Field of the Invention

This invention relates to betting methods and media for expressing opinions.

2. Description of Related Art

U.S. Pat. Nos. 5,575,474 and 6,443,841 disclose methods and systems for using bets to communicate. The Iowa Electronic Markets (http://www.biz.uiowa.edu/iem) enable users to express their opinions on several matters, especially who is going to win an election. The Hollywood Stock Exchange (www.hsx.com) provides a market system for enabling users to express opinions on how movies and movies stars will perform. Robin Hanson (http://hanson.gmu.edu/gamble.html, http://hanson.gmu.edu/myPAMpress.html) has proposed using a betting market to allow people to express scientific and policy opinions.

It is well known that market prices convey information. Some academics theorize that the price of a stock represents “all information” that is known about a company and, further, that material information about a company is almost instantly reflected in the price of a stock. Other people disagree and feel that information disclosure can be improved.

This specification describes a betting method and medium with novel rules and processes that create a better way to disclose estimates of a company's financial condition. The method and medium are founded on the idea of enabling company “insiders” to make bet offers on specific financial questions regarding their companies.

Many economists have long said that insider trading in stocks should be legal because it generates useful “information” for investors. For instance, Milton Friedman stated in a recent interview (Mar. 12, 2003) on CNBC, “a person on the inside who knows things are going wrong, who just engages in selling in Enron stock can make money on it and at the same time serve the market purpose of driving down the price of a stock.”

While the sale of a stock may convey “information,” no one can say what that information is. The term “information” is too vague and the movement of the price of a stock can have many causes. What, for instance, does it “mean” if the price of IBM declines $2, or if the CEO of IBM sells 10,000 shares?

Investors are not interested in information. They are interested in specific answers to specific questions, such as, “What will revenues be next year?,” “What will profits be next year?,” and “Will you default on your bonds in the next 5 years?”

There is no complete list of such questions; the answers sought will depend on the investors. However, the answers to such questions should usually include probability estimates. Bet with probability estimates (odds) can be constructed that provide answers to these questions.

Indeed, a bet offer is an answer provided by a particular person to a particular question.

Investors not only want specific answers, they usually want those answers from particular people involved with a company. Hence, bet offers made by identified insiders can be a far better way than insider stock sales to provide investors with the answers they seek.

Part II of this specification discloses more specific, narrower methods for using bets to elicit estimates of future performance of a fund (investment vehicle). John Train in The Money Masters, circa 1980, proposed a somewhat similar type of betting to reveal the views of technical analysts about their forecasting of stock market movements.

Part II further discloses methods for sorting and evaluating investments according to betting data about the performance of those investments.

Part II contains “new matter” over provisional patent application 60/471,539 and PCT application US03/13011 (Part I of this specification), but also assumes the methods of Part I and all currently known betting methods and systems.

### BRIEF SUMMARY OF THE INVENTION

We disclose a betting method and medium that identify a company's “insiders” and enable these insiders to make and transact publicly displayed, non-anonymous bet offers about subjects that are important to the company's financial condition and/or prospects. The invention enables users to make bets about a variety of well-known financial measures and events, such as earnings, return on investment, bankruptcy, and so forth. The invention enables users to make bets about how well an investment company will perform compared to a benchmark or an alternative investment. The invention provides for displaying bet offers and agreements by identified insiders, thereby providing a new kind of financial disclosure.

### DETAILED DESCRIPTION OF THE INVENTION

Contents

Part I

Section 1: Problems of Public Company Financial Disclosure
Section 2: Solution: Method and Medium for Insiders to Make Public Bets
Section 3: Useful Financial Bets and Their Forms
Section 4: Users: Insiders, Authenticators, Outsiders, Viewers, Judges
Section 5: Steps for Transacting and Displaying Bets
Section 6: Attaching an Explanatory Comment to a Bet
Section 7: Displaying How Much Money an Insider Is Risking
Section 8: Recording, Compiling and Displaying Betting Statistics about Insiders
Section 9: Incenting Insiders to Place Bets
Section 10: Preventing Cheating.
   Part II
Section 11: Estimating a Fund's Future Performance, General Problem and Solution
Section 12: Using the Methods of Part I and Other Known Betting Methods
Section 13: Constructing a Performance Question to Bet on
Section 14: Sorting Investment Vehicles According to Bet Data.
   Section 1: Problems of Public Company Financial Disclosure

By disclosure we mean the processes by which financial information about a company becomes public. We do not restrict the term to how executives tell the public about their companies. We mean how the investing public finds out answers about a company.

There are well-known problems with the disclosure/discovery of financial information about public companies. We mention but several:
Executives often have a powerful incentive to be overly optimistic.
Analysts who cover companies often have an incentive to be overly optimistic.
Even when executives and analysts give their best guesses, they may not have the best “ground level” information. Their information is often second and third-hand—they must rely on their subordinates, who in turn may be relying on subordinates.
It is hard or impossible to get “real-time” financial data about a company; an investor must wait for formal disclosures—e.g., quarterly reports—by a company.
The informal “leakage” of information about a company comes in the form of rumors.
The informal “leakage” of information about a company may favor certain people who are “closer” to insiders.

How to get information “out” to the public is an unsolved problem. The inventor knows of no good theory about how this process occurs or should occur. Attempts to regulate the process, such as Regulation FD in the United States, do not fundamentally improve the quality of the information or the timing of disclosures.

Section 2: Solution: Method and Medium for Insiders to Make Public Bets

The inventive solution is to enable company insiders to make public bets about financial measures and events concerning their companies. For example, a bet might be about whether or not a company will beat management's yearly revenue estimate.

Insiders have the “best” information and bets enforce honesty—they counter over-optimism. Additionally, a market medium is relatively real-time compared to periodic, official company disclosures, such as quarterly reports. Therefore, public bets and a betting medium can be a better way of revealing the financial condition of a company.

Currently there are regulations against “insider trading” because it is recognized that insiders have “better” information than outsiders.

The inventive solution is to create a betting medium—some might call it a market—that takes advantage of this “information edge.” This medium would allow “insider trading” and identify the bettors who are insiders. In this way, near real-time information—the opinions of insiders—is generated and instantly shown to users of the system.

Thus, the key rule of the inventive method is: in a bet, if an insider is making a bet, that fact is shown as, as is the side of the bet, and the stakes that are being bet.

(A medium that implements the method can also allow bets in which outsiders take both sides of a bet, but the key is that the medium shows when and how insiders bet.)

In addition to identifying insiders, the inventive method encompasses bets about key financial statistics and events that are of interest to investors.

The rest of this specification will explain this method and specific embodiments and sub-methods. Also described is a computer database apparatus, the medium, for enabling the method to be implemented and used by people.

Section 3: Useful Financial Bets and Their Forms

Bets can be constructed in a great variety of forms and with an endless variety of particular rules. In this specification, we do not add to the art of creating forms of bets. The inventive method and medium can include steps for enabling any type of bet offer and agreement, including bets that are in the form of tradable securities.

Of particular usefulness are four general forms of bets:
Even odds bets in which users bet at even odds (not counting any commission assessed by the medium).
Variable odds bets, in which a user making a bet offer can set his odds.
“Quantity bets” in which the amount that one party pays to an opposing party depends on the quantity of a measure being bet upon.
Securities bets in which financial measures are cast in the form of securities that users buy and sell as, for example, in the Hollywood Stock Exchange (www.hsx.com).

The general principle is that a user makes a bet offer (which could be an offer to sell a security) that can be accepted by another party. The user “puts his money where his mouth is.” A user who accepts the offer also “puts his money where his mouth is.”

A betting medium of the type described here can also enable a user to make a binding bet offer such that the user cannot retract the offer, or can retract the offer and pay a penalty, possibly to another user. The reason for this kind of condition is that it may make the offer more believable.

This kind of binding offer was described in U.S. Pat. Nos. 5,575,474 and 6,443,841. Those patents also described “range bets” and “profit margin” bets and a variety of other specific bet forms that serve to encourage honest probability estimates. All these bet forms can be included in the invention described in this specification.

While not breaking new ground regarding the form of bets, this specification does describe the subject matter of those bets, i.e., the bets can be about important financial measures of a public company over any specific period of time. Important financial measures include, but are not limited to:
Sales
Sales growth
Earnings
Earnings growth
Earnings per share
Return on equity
Assets
Asset sales
Debt levels
Cash flow
Cash reserves (including marketable securities).

Additionally, the invention can enable bets to be made about material events that are to take place or that might take place. For example, three important bet questions concern:
Will a company will go bankrupt?
Will a company will default on a loan?
If a company defaults on a particular loan (e.g., a bond), what percentage of the debt can be recovered?

Bets on these subjects would yield new measures of the credit risk of a company.

One example of such a bet is a probability bet in which a bettor sets the odds that a company will go bankrupt by a particular date.

Another example is a securities type bet where the price of the security is a function of a bettor's estimate of the probability of default on a loan.

Still another example is a bet about whether the price of a company's bonds will be higher or lower at a specified date in the future than at today's prices.

Importantly, bets can also be about management's estimates of financial measures. Thus, a bet can be about whether management's estimate is too high or too low—for instance, whether management's estimate of earnings for the next quarter is too high or low. Or, a bet can be about how close management's estimate will be to an actual number—for instance how close management's estimate of earnings will be to the actual number.

Any financial measure, or material event, can include custom definitions. For example, “revenues” might exclude extraordinary events, such as the profit from an acquisition. Earnings could be defined in innumerable ways: GAAP, S&P Core earnings, pro form a, and so forth. The meta-rules of the medium can, and likely will, include definitions for standard bets that are transacted through the medium.

Because the definitions of many financial measures and events are subjective, the method and medium can also include processes for enabling a judge to enter an opinion and to enter the result of the bet.

Of course, the price of a company's stock is an important financial measure, and so, a variety of bets can be made about a company's stock price. One example is a bet about whether the price of a company's stock will be higher or lower than today's prices a specified date in the future. An even odds bet can be highly informative. For instance, if a high proportion of insiders are betting at even odds that the price of a company's stock will be lower one year in the future, that betting pattern can tell investors to steer clear of the stock. Probability bets can be employed, of course, as can securities type bets. Another example is a bet in which insiders try to guess what the price of stock will be at some date in the future. One way this kind of bet can be done is the way that users bet on the Hollywood Stock Exchange (www.hsx.com) on how much a movie will gross.

A bet offer may be directed only to insiders at a company, or to a particular class of insider, or to a particular insider, such as the CEO of a company. Only the party it is directed to can then accept such an offer.

Different companies and different bettors will prefer different financial measures that are particular to a given industry. For example, measures of “same store sales” are important in the retail industry but not in the pharmaceutical industry.

Of course, the method and medium can enable bettors to create their own custom bet offers regarding any financial measure or event that they think is important.

New Matter Not Disclosed in Provisional Patent Application

For stock or bond investors, the ultimate question is: Is this stock or bond undervalued or overvalued? Answering this question requires plugging estimates (assumptions) into a “model” which may be in someone's mind or which may be explicitly stated as a formula or as a series of screens. There is infinite variety of such valuation formulae and screens.

It is possible to present more than one financial measure to be bet upon by an insider, so that the insider bets on a set of variables at once.

We mention this possibility because it may arise that certain formulas, and hence, sets of variables, for evaluating stock and bond prices may become popular.

If this happens, then the medium can automatically also calculate whether an insider's estimates (expressed in bet offers) when plugged into a valuation formula/model, yield a verdict of undervalued or overvalued, and yield the amount of undervalue or overvalue.

Now, the value of a stock or bond is relative, depending variables that insiders should have no special insight about, especially the interest rate on Treasury Bonds. Thus, any the system can include formulas that are calculated to yield a valuation estimate can enable users to plug in their own assumptions about key variables, especially variables that insider's should have no special insight about.

To decide whether a stock is fairly valued, investors may try to estimate total retained earnings per share over the long term. Thus, investors value the honest estimates of well-placed insiders about accumulated, after-tax earnings per share over a specified period of years. So, the inventive method can include bet questions in which insiders are asked:
What will total retained earnings per share be added up over a period of X years?

Total retained earnings can be defined in detail and incorporated by reference into a bet question, and the number of years, X, can be specified.

Section 4: Users: Insiders, Authenticators, Outsiders, Viewers, Judges

The method and medium have four classes of users (and possibly a fifth):
1. Insiders
2. Authenticators
3. Outsiders
4. Viewers
5. Judges (possibly).

1. Insiders

There is no precise definition of an insider. Any implementation of the method will include a definition of an insider and possible sub-classes of insiders. As a broad definition, an insider may be a person who works for a public company or for a supplier to the company or for a competitor of the company or for a customer of the company.

Then, there can be sub-classes of insider, such as:
People who work for a company
People who work for a competitor
People who work for a supplier
People who work for a customer company and people who are customers
Analysts who cover a company.

Then there can be additional sub-classes, such as:
Executive
Sales department
Marketing department
Finance department.

Insiders can also be identified by their exact position/title in a company.

Insiders can also be identified by their names.

An insider is usually an individual, but it may also be possible to enable companies or legal entities to be considered insiders. If a company is acting as an insider in making a bet offer, the company will be identified as the bettor.

2. Authenticators

An authenticator is a user who is granted privileges to validate whether a user who claims to be an insider is indeed an insider according to the meta-rules of the medium. An authenticator would investigate a user who claims to be an insider and enter a designation into the medium validating the user's claim or rejecting the user's claim.

3. Outsiders

An outsider is a user who does not claim to be an insider and who is using the method and medium to bet. An outsider may be an individual or a company or legal entity.

4. Viewers

A viewer is anyone who views the bets that are displayed by the medium. Viewers can be divided into sub-classes that are granted different privileges in viewing bets. Some viewers, for example, may be charged for viewing bet data.

5. Judges

A judge is a user who is authorized to rule on the outcome of a bet, where subjective terms are involved. A judge may also be needed to enter the result of a bet in cases where the data for settling the bet is not available via computer network. If the data is available via computer network, the medium can simply pull that data and declare a winner to the bet. Even so, a person, a “judge” may be needed to validate the bet data and the result.

(Note: The medium will also accommodate system administrators. We omit discussion of their role, as it does not add to the novelty of the inventive method or medium.)

Section 5: Steps for Transacting and Displaying Bets

The inventive method is implemented by and through an online computer database system, which we will call the system or the medium. To make use of the method, users interact with the system and with each other, through the system, via terminals.

The method can be divided into sub-processes that include the following:
Process for Insider Authentication
Process for Placing a Bet Offer
Process for Accepting a Bet Offer
Process for Settling and Recording Bets
Process for Displaying Bets.
   Process for Insider Authentication

In the inventive method it is critical that insiders are genuinely insiders. They need to be authenticated by a person, an authenticator, who is authorized to enter, into the medium, a designation of “authentic insider” for a user.

A user who wants to be an insider would request authentication and possibly pay a fee. An authenticator would then be informed by the medium. The authenticator would then investigate the user's request, and then enter an authentication or rejection. The user would be informed as to the result of the authentication process. Re-authentication could be undertaken periodically or according to a set of rules, so those insiders whose employment situation changes would have their system status change along with it.

Thus, the inventive method includes the following steps:
A user submits a request for authentication.
The user submits name and employment data.
The user indicates whether he wants his name and exact position hidden, or whether he wants to be completely public. Further, if sub-classes of insider exist, the system can include means for enabling the user to choose/enter the sub-class he wants to be in.
An authenticator receives the request and investigates the user. If the authenticator finds the user is not an insider, he rejects him. If he finds that the user is an insider, he classifies the insider and enters an authentication designation into the medium that allows the user to log-on as an insider and that classifies the insider to the medium. The user is issued a screen name. A profile of authenticated information is created for the user. As discussed below, the insider can decide how much of this information to reveal along with a bet offer.
The user is informed of whether he has been authenticated or not.
The user's insider classification is displayed along with the user's bet offer.

The system may also include steps for assessing the user a fee for being authenticated. If so, the system will present an authentication fee to the user for his approval or rejection.

Reducing the Cost of Authentication

Since it can be quite costly to authenticate insiders, methods can be employed to lower this cost.

One method is an audit method in which a user purporting to be an insider puts up a deposit. The user is granted the status of “insider” to the medium but is subject to random audit by an authenticator. If the user is audited, and it is found that he is not an insider, then his deposit is forfeit.

Another method is one where users who purport to be insiders can be granted the status of insider without an inspection. But, these users also have to identify themselves by name and/or title. Then, if a user is impersonating someone, the genuine person can challenge the impersonator. Accordingly, the method can include steps for enabling anyone to challenge any insider's designation and call for an inspection. A user making a challenge might have to put up an amount of money at risk. If the investigation finds that the challenged user is indeed an insider then the challenger would forfeit the challenge fee. If the challenged user is an imposter, then the imposter would be penalized.

Another, and related method is one where all users who purport to be insiders are granted the status of insider and have to put up a deposit. Users are also granted the right to challenge any insider's designation and call for an inspection. A user making a challenge would have to put up an amount of money at risk. If the investigation finds that the challenged user is indeed an insider then the challenger would forfeit the challenge fee. If the challenged user is shown not to be an insider, then the challenged user forfeits the deposit, and the challenger would win an amount of money. In this way, users could police each other.

Process for Placing a Bet Offer

An authenticated insider logs on and places a bet offer (the offer may expire by a specified time) about the financial condition of a company.

The bet offer will often include:
a statement that can be found true or false
a probability estimate (the odds or the price of a security)
a choice of true or false (or buy or sell, in the case of a securities bet)
and an amount of money at risk.

Certain kinds of bets will not include probability estimates.

For example, in the case of a security bet, the price at which a security trades, like a conventional exchange traded option, may be based on how close a bettor's estimate of a number is to the actual number at a given date. For instance, a company's reported revenues might determine the ultimate value of a security at a specified date. In cases like this, a statement that can be found true or false is not part of a bet. Differently, a financial measure and date are specified and the ultimate value of the security is based on that measure at that date.

More generally, we can say that a bet offer will include:
1. statement that contains the description of an objectively verifiable fact that will be known at some future date,
2. terms that define how the result of the bet is determined by the resolution of said fact and that define how money at risk is to be paid from the winner(s) of the bet to the loser(s).

The offer is displayed such that viewers can see it and accept it.

A time stamp on the bet is shown.

Differently from conventional betting methods and media, the fact that an insider has placed the offer is shown, as is the insider's sub-classification.

The inventive method and medium further include steps for enabling an insider to reveal as much authenticated profile information about himself as he desires—he can be anything from nearly anonymous (being classified only as an insider) in a bet offer to providing his full name. This capability to be anonymous, while still demonstrating that one is an insider is an important feature of the inventive method and medium.

The offer is stored such that it can be looked up by company name, and further, by the subject (content) of the bet and by the type of bet, and also, possibly, by a bettor's real name and/or screen name.

An outsider may also place an offer.

The medium can include steps for enabling an insider or outsider to direct a bet offer to a particular insider, such as the CEO of a company. In this case, the offer can only be accepted by the party or parties it is directed to.

Process for Accepting a Bet Offer

A bet offer may or may not be accepted. If it is not accepted, the lack of acceptance is shown and is still valuable information.

Assuming it is accepted, the following steps are executed:

A second user, he may be an insider or outsider, logs on and finds an open bet offer.

The second user accepts the offer.

The medium can include means for enabling an insider to be chosen over an outsider if both insiders and outsiders act to accept a bet.

The acceptance is displayed, as is the user's screen name and the user's class, insider or outsider. If the acceptor is an insider, and sub-classes exist, then the insider's sub-class is displayed as well.

If the offer is directed to a particular insider, then only that insider can accept the offer.

The inventive medium can include means for implementing these betting directions.

Note on Matching Up Offers and Matching Up the Money at Stake

In the explanation above, we use the terms placing and accepting an offer. We might have said that users enter offers that are matched up by the medium.

Processes for matching up bet offers are well known in the art.

One important aspect of matching up offers is that two opposing offers may not be equivalent in the amount of money at stake—in other words, one bettor's offer may not have enough money to “cover” another bettor's offer. For example, if a bet offer is at even odds, and the amount a bettor has at stake is $1,000, then an opposing bettor needs to risk $1,000 to cover the first bettor's offer.

The medium can include steps for enabling bettors to partially cover the stakes of other bettors. We do not delve into these steps of the method and medium because the processes are well known in the art. We simply note that the method and medium can include steps for accommodating the partial covering of bet offers.

Process for Settling and Recording Bets

If a bet offer is not accepted, and time has expired on the bet offer, then the medium stores the lack of acceptance. If practical, the medium registers what the result of the bet would have been, if the bet offer had been accepted.

If the bet offer is accepted, the medium registers the result of the bet when the bet is settled. A judge or an administrator may enter the result of a bet. Or the result may be entered by automated means that automatically pull the relevant data from a financial data source (for instance, if a bet is about a company's revenue, the revenue data could be pulled automatically from a trusted source).

If the result is registered, the medium stores the result in the user's or in both users' performance history(ies), as discussed in Section 8 below.

Definitional note: the result of a bet is a somewhat broad term that means the outcome of the bet. Hence the result of a bet will encompass:
the determination of the judge as to the fact that is the subject of the bet
which bettor(s) won or lost the bet
how much money each bettor won or lost.

In settling a bet, then, the invention can also provide for transferring funds from the loser(s) to the winner(s) according to the terms of the bet.

Process for Viewing Bets

In the processes for placing, accepting and settling bets, we described the displaying of certain kinds bet data. Here we reiterate and describe additional data that can be useful.

The medium can include search means for enabling viewers to see:
All the bet offers and bet agreements made about a company by insiders
What offers have been accepted and what offers have not been accepted
Whether a company's management, such as its CEO, CFO and other key officers have engaged in bets about the company, and whether they have accepted bet offers made by other insiders.

Viewers may have to pay for the bet data they view.

Section 6: Attaching an Explanatory Comment to a Bet

In addition to a bet as an expression of opinion, a user may want to add a comment explaining why he bet the way he did. This kind of comment can be quite valuable to other users. Thus, the inventive medium can include steps for enabling a user to post such a comment along with his bet.

Section 7: Displaying how Much Money an Insider is Risking

The amount of money an insider risks in a bet is part of his bet offer or his bet acceptance, so users who view the offer see the amount. Yet, an absolute figure may not be adequate for judging whether a bettor is taking a large risk, is putting a substantial amount of money where his mouth is. If a CEO wagers $100, that does not mean very much.

The amount of money at stake relative to one's personal resources has bearing on the meaning of a bet. So, additional data can be provided to show how much the amount at risk compares to the insider's net worth and/or compensation.

Accordingly, the method can include steps for including an insider's net worth, and/or compensation, in the insider's profile.

And, the method can include steps for showing how the amount at risk compares to an insider's net worth and compensation.

(Net worth and compensation are subjective terms, and the definition of these terms will depend upon the particular implementation.)

Further, the method can include steps for verifying the veracity of the insider's claims about his net worth and compensation. Verification/authentication processes were discussed above in Section 5, and the verification of net worth and compensation can be included as part of those processes.

Section 8: Recording, Compiling and Displaying Betting Statistics about Insiders

How does a user know if an insider's opinion—expressed in a bet—is reliable? The best way is to look at the insider's betting record. Just as an investor may pick a mutual fund based upon the record of its fund manger, a user will want to know an insider's betting history. In a conventional market, such as a stock market, a trader's record is not seen because it could put the trader at a disadvantage. However, as the purpose of the inventive medium is better disclosure, the approach of showing the insider's betting record furthers the object of the invention.

Thus, the medium can include means for saving an insider's betting records and for compiling useful statistics. For example, a viewer could see the fraction of times that an insider wins even-odds bets regarding his company's revenues. Most tellingly, perhaps, the medium can show the profitability of an insider's bets.

Accordingly, the medium can enable users to look up an insider's betting record and betting statistics.

Further, the medium can also include steps for charging users for seeing an insider's betting record and for paying the insider for access to his record, since this information can be valuable.

Section 9: Incenting Insiders to Place Bets

A problem may exist with the invention as described: insiders may have no incentive to place bets. This lack of incentive can be seen in conventional stock markets. Insiders don't reveal themselves in a trade because the counter party might avoid the trade, thinking that the insider has special knowledge. To overcome this lack of incentive, the invention can incorporate methods for paying insiders for posting bet offers.

The inventive medium can enable a payment offer to be directed to insiders of a particular company, or to a sub-class of insider, or to a specific insider identified by his user ID, or to insiders whose betting records match specified criteria (an insider's bets may be more valuable according to his betting record).

Insiders may be paid when other users view their bets because their bets are valuable opinions. The fee could be standard or custom. Thus, a medium for implementing the inventive method can include means for enabling insiders to be paid when their posted bets are viewed. Additionally, payments can vary depending on:
1. whether a bet is in the offer stage or it is a binding (non-retractable) agreement
2. the amount of money the insider is willing to put at stake in a bet offer.

Insiders may also be paid to post a binding (non-retractable) bet offer. Thus, the medium that implements to inventive method can include means for enabling users to offer to pay an insider to post a binding bet offer. The payment can be standard or custom, and can vary according to the type of insider—e.g., the CEO or CFO can be specified—making the offer, and the amount of money the insider is willing to put at stake.

Conversely, the medium can enable an insider to solicit bids for his opinion. That is, an insider can ask users to pay him an amount of money to make a binding bet offer.

(Means for transacting payment are well known so we do not describe these means.)

Section 10: Preventing Cheating

Outsiders can dishonestly manipulate bet offers by insiders. Although the panoply of possible cheats cannot be described here, let us just discuss three kinds of cheating and methods for preventing them.

1. Outsiders Paying Insiders to Make Bogus Bets

Let us assume that an outsider, a manipulator, wants to give the impression that a company is less healthy than is commonly believed. The manipulator can pay an insider to post a bet offer than provides a negative estimate of the company's earnings. It is not clear how to stop this cheat. One deterrent may be a function that the medium can include for tracking an individual insider's bet offers and measuring the reliability of the insider's bets, for instance, the profitability of those bets. Presumably, a bettor giving dishonest probability estimates will have unprofitable bets over time, and his bet offers will not be relied upon. This method of discrediting an insider may provide some safeguard against bogus bet offers, but is not a perfect solution, of course.

2. Outsiders Using Insiders as a Front

An outsider may enable an insider to bet a large amount of money, money that is provided by the outsider. This kind of outsider money can distort the honesty of bet offers, especially if the money is staked as part of a dishonest bet intended to manipulate the market. Further, if insiders do not risk their own money, they can be less inclined to give honest opinions. To prevent outsiders for providing money to insiders, the method and medium can include steps for tracking how much money is risked by an insider and, further, auditing insiders who appear to be betting beyond their means, or who “trip a flag” that has been established as a measure of possible proxy betting. As an example, a simple flag can be that someone whose salary is less than $100,000 risks more than $20,000 in single bet.

3. Insiders Hedging (Laying Off) Their Bets

An insider may make a large bet, appearing to strongly express an opinion through a bet. But, he may reduce or virtually eliminate his exposure to loss by secretly hedging (laying off) the bet. The inventive medium can enable users to see all the bets an insider makes, but if the bet is made secretly, or outside the medium, then no one can find out. Hence the inventive method and medium can also include steps for:
a. having a user pledge not to hedge a bet
b. having a user pledge to open financial records to an outside auditor who can potentially find a hedged bet
c. displaying one or both of these pledges along with the insider's bet offers.

### Part II

### Betting Methods for Estimating a Fund's Future Performance

Contents of Part II (Repeated from Above)

Section 11: Estimating a Fund's Future Performance, General Problem and Solution
Section 12: Using the Methods of Part I and Other Known Betting Methods
Section 13: Constructing a Performance Question to Bet on
Section 14: Sorting Funds According to Bet Data.
   Definition

Fund will refer to any investment vehicle. Although the term mutual fund is often used below, the invention can be applied more broadly to elicit estimates about any kind of investment vehicle.

Section 11: Estimating a Fund's Future Performance, Problem and Solution

With approximately $7 trillion under management in the U.S., mutual funds are the favored vehicles for investing by the public Yet, part of the mutual fund industry may be crooked in the sense that many fund managers float high-fee generating funds that they think will appeal to an ignorant public, whether or not the managers think the funds will perform better than a low-fee index fund. An article in Forbes, The Great Fund Failure (Sep. 15, 2003), discussed some of the problems facing investors:
Vanguard's 500 Index fund—a passively managed fund that tracks the market—has returned 9.2% annually after taxes over the past ten years. The average actively managed equity fund, by contrast, has returned only 5.3% annually. That comparison, by the way, is too kind to the funds. This return is before subtracting sales commissions, and it counts in the fund average only the survivors . . . .

The nation's 95 million investors in mutual funds are overwhelmed by the competing claims of 8,300 funds. They often are clueless about how to win at a fund game on which their financial futures depend . . . . The Securities & Exchange Commission hasn't been much help. It could mandate disclosures that would cure this mass ignorance but is too timid to do so.

In order for a person to invest in a fund, she would like, at least, to know that the management of the fund believes that the fund will, on a risk-adjusted (expected value) basis, equal or outperform the market averages or a no-load index fund.

What is needed is a way to reveal what fund managers and other experts honestly believe about how well a fund (or by extension any other managed investment) will perform.

Solution

Bets are a form of expression for stating opinions and estimates—bet opinions/estimates.

Specialized bets can be constructed that enable people bet on the future performance of investment funds. These bets can be offered and transacted by the managers of funds. These bets can also be offered and transacted by any member of the public.

This specification discloses methods and media for enabling users to construct specialized, useful bets concerning the performance of funds—that is, of any investment vehicle/company—and for enabling people to see the bet opinions of bettors concerning the performance of funds.

Also disclosed are sub-methods for enabling these bets to be transacted by publicly identified managers of funds. If senior fund managers—identified by name, title, organization and specific fund—bet substantial amounts of money on whether their funds would outperform a no-load index fund, net of fees, then the public could see the managers' bet opinions on how well those funds will perform.

If the stakes were high enough managements would, in most cases, only bet on funds they honestly believed would do better than an index fund.

The public offering and transacting of bets offers concerning fund performance provides a better way than currently exists for generating estimates of the fund performance.

Further, the lack of bet offers, especially by insiders of a fund, can be shown as well by the inventive method and medium, thereby providing very useful information.

For example, if the manager of a fund company is unwilling to bet, at even odds—with perhaps a reasonable profit margin built in—that his fund will outperform an S&P index fund, then that manager indicates that his honest estimate is that his fund will underperform the index fund.

This kind of betting, if required by law, could dramatically improve on, and obviate, the need for most regulation of the fund industry. Current regulations may prevent outright fraud, but are otherwise ineffectual. Anyone can float a fund if they have enough money to spend on the voluminous paperwork required which tells investors nothing more than:
This fund will be professionally managed, but we can't predict its performance in any way, and you risk losing your money.

A far better disclosure is one in which a senior manager expresses a precise bet opinion about the estimated performance of his fund. Better still are bet disclosures by all the senior managers in a position to estimate a fund's performance.

Section 12: Using the Methods of Part I and Other Known Betting Methods

The methods disclosed in this Part II are to be incorporated into the methods of Part I and into existing betting methods and systems. For clarity's sake, we will mention certain necessary steps in this Section 12, but will mainly say that they are incorporated by reference from Part I and from well-known betting methods and systems.

In this Part II, we focus on disclosing possibly novel content that can be included in a bet, and on sorting methods that can be used in conjunction with this content.

Forms of Bets

Any known form of bet can be used, such as even odds bets, variable odds bets, securities type bets, and quantity bets (see U.S. Pat. No. 6,443,841).

Note on Penalizing Managers for Poor Performance

A major objective of the invention is to elicit honest opinions of the managers who float funds, such as CEO's of mutual fund companies, and the managers who directly invest for the finds. So, if these people bet, they need to have a real expected penalty for a loss. Even a large bet, may not pose much of a loss on a “risk-adjusted” (expected value) basis. For example, if a manager feels the probability is 49% that one of his funds will outperform the S&P, then a $1,000,000 bet at even odds does not pose much of an expected loss—only a $20,000 expected loss (a 49% chance of winning $2,000,000).

So, forms of bets should be used that ensure that the manager has a real expected penalty.

A bet in which the manager loses $x for every basis point of underperformance may be a good alternative. Other methods may be useful as well.

Enabling Users to Make Bet Offers

The methods of Part I and known betting methods and media can be used to enable users to make bet offers. These methods are incorporated by reference.

Identifying Bettors, Particularly Top Executive Insiders

The methods of Part I and known betting methods and media can be used to enable users to identify bettors. These methods are incorporated by reference.

Transacting Bet Offers

The methods of Part I and known betting methods and media can be used to enable users to transact (match up and settle) bet offers. These methods are incorporated by reference.

Section 13: Constructing a Performance Question to Bet on

The object of the invention of Part II is to elicit honest estimates of fund managers about the performance of their funds relative to a specified yardstick or yardsticks. So, it is necessary to construct specialized bets about performance looked at this way.

The bets will be about whether a fund will outperform or underperform. Outperform means to have a greater rate of return than a specified yardstick (see examples below); underperform means to have a lower rate of return than a specified yardstick.

Accordingly, the invention provides a method (or apparatus) for: entering a bet about whether a named fund will outperform or underperform:
1. A named market average such as the S&P 500
2. A named index fund, net of fees
3. A named interest rate (such as a 10-year Treasury Bill).

Accordingly, the invention provides a method (or apparatus) for: entering a bet about how many basis points a named fund will outperform or underperform:
4. A named market average (such as the S&P 500)
5. A named index fund, net of fees
6. A named interest rate (such as a 10-year Treasury Bill).

In creating/entering a bet offer, a bettor will perform the step of naming name the fund and naming the comparison yardstick, and further, the bettor will enter additional information as required by the bet form being used. For example, a bettor might enter the number of dollars he will risk per basis point of under/over performance by his fund.

As part of a performance bet, a bettor will need to specify (unless there is a default) the period of time in which the comparison is to take place. Thus, entering/creating such a bet will involve setting a beginning and ending time for the measurement of performance of the named fund and the named comparison yardstick.

Section 14: Sorting Funds According to Bet Offer Data

There are around 8,300 mutual funds in the U.S. and hundreds of thousands of other investment vehicles that people can invest in. Investors want to know which ones to pick. Currently, people usually sort and screen funds according to past returns (past performance). But past returns may tell little about future returns.

Investors would like reliable estimates of future returns, estimates that can be sorted/compared.

As discussed, bets offers can be used as estimates of future returns. Further, bet offer data can be sorted to order investments according to bet estimates of future returns.

Thus, the invention can provide a method (or an apparatus) for sorting and/or screening funds according to data generated by bet offers about those funds. By bet offer we will mean both offers that are open and offers that are matched.

Additional data generated about settled bet transactions can also be screened/sorted.

The automated and displayed sorts and screens described below can be included in the invention, alone or in combination. (Investors will often use more than one screen to select a sub-set of funds that can then be sorted.)

The main questions that will be bet upon concerning funds were described in Section 13. We assume that the inventive medium stores and displays data that is generated by betting on these questions. So, outperform below we will mean:
1. Have a rate of return that is greater than a specified yardstick such as a named market average, index fund, or interest rate
2. Have a rate of return that is greater than a specified number of basis points above the return of a specified yardstick such as named market average, index fund, or interest rate.
   A. Sorting/Screening by Odds (the Higher the Odds, the Higher the Sort)

Funds can be sorted/screened according to odds that are given that a fund will outperform a named market average, or a named index fund, or a named interest rate. The higher the odds, the higher the position the fund is sorted to.

For example, if odds are given of 1-3 (75%) that Fund A will outperform the S&P 500, and 1-1 (50%) that Fund B will outperform the S&P 500, then Fund A at 1-3 will be ranked above the Fund B at 1-1 in a sort.

Odds can be defined as the current odds given. Or, odds can be defined as an average of the odds offered over a period of time in all the bet offers made in that period of time about those funds. Other kinds of averages of odds can be used as well. There is no accepted definition of market odds. The definition used (made operational) will depend on the implementation.

B. Sorting/Screening by the Amount of Money Bet that a Fund Will Outperform

Funds can be sorted and/or screened according to how much money is bet that a fund will outperform. For example, if $500,000 is bet that Fund A will outperform, and $200,000 is bet that Fund B will outperform, then Fund A will be ranked above Fund B in a sort.

Funds can also be sorted and/or screened according to how much money insiders are betting that a fund will outperform.

Funds can also be sorted and/or screened according to how much money CEO's of the funds are betting that the funds will outperform.

C. Sorting/Screening According to the Proportion of Money Bet on Outperform

If bets are made at even odds, funds can be sorted and/or screened according to which funds have the highest proportion of money bet on outperform.

D. Sorting/Screening According to “Point Spread”

If bets are made at even odds, then a “point spread” (basis point spread) method may be used such that the amount that a fund will outperform (or underperform) is bet upon.

If the point spread method is used, funds can be sorted and/or screened according to the highest point spreads being offered.

For example, if the point spread is on Fund A is 500 (meaning that people are betting that Fund A will outperform by 5%), and the “point spread” on Fund B is 300, then Fund A will be ranked above Fund B in a sort.

As with odds, point spreads can be defined as the most recent (current) offer, or by some average of past offers over some specified period of time.

E. Sorting/Screening According to the Proportion of Bettors Betting on Outperform

Funds can be sorted and/or screened according to the proportion of bettors betting on outperform compared to underperform.

F. Sorting/Screening According to the Past Record of Bettors—Esp. Senior Managers

Funds can be sorted and/or screened and/or screened according to the past performance of bettors betting on the funds. That is, if a person is an investor, he might want to know that a bettor, especially a senior manager, who is betting on a fund, has had a winning record in previous bets. That may give an investor more confidence in the bettor's estimate, expressed in the bettor's bet.

A senior manager of a fund may have be attempting to deceive when making a bet offer. He may state in the bet that he is confident that his fund will outperform, just to display that bet offer to investors. But, if the senior manager has made a series of bad bets, his deception will be revealed, and an attempt to show confidence in a bet may backfire.

Thus, a senior manager's record in previous bets can be used as a sort and/or screen. For example, an investor could ask the inventive medium to only show funds where senior managers have bet at greater than even odds that the funds will outperform, and further where the senior managers have had a record of profitable bets in the past.

A somewhat related sort and/or screen is the number of bets that senior managers have made in the past. For example, an investor might only want to see funds where the senior managers have made ten or more bets about the returns of the fund.

Thus, the inventive method and medium can provide for sorting and/or screening funds according to betting performance of senior managers who have bet on those funds. In particular, the invention can provide for sorting and/or screening according to the net profits of senior managers who have bet on funds.

G. Sorting/Screening According to the Level of Outperformance Being Bet on

An investor may only want to see funds that bettors bet will outperform by a certain number of basis points.

For example, an investor may only want to see funds where bets have been placed that the funds will outperform the S&P 500 by 200 basis points or more.

Thus, the inventive method and medium can provide for sorting and/or screening funds according to the level of outperformance stated in bet offers, in which bettors are betting on outperform.

H. Sorting/Screening According to Expected Profit, as Indicated by Betting Data

When a bet is offered with odds, the odds can be interpreted as a probability estimate.

Further, when a bet is offered about whether a fund will outperform by a certain number of basis points, the bet offer has a statement that specifies the number of basis points.

The probability estimate (the odds) multiplied by the number of basis points will yield an expected return in terms of basis points.

For example, if a bet offer is made at even odds (probability estimate of 50%) that Fund A will outperform by 10% or more, then the expected return is 5% or more.

Funds can be sorted and/or screened according to expected return, defined in this way.

Ideally, to calculate an expected return on a fund, bet offers would cover a range of outcomes and provide a probability estimate for each outcome. The outcomes multiplied by their associated probabilities would be summed, yielding an expected return. This kind of method, and related methods can be included as well.

The mathematically implemented definition of expected return can vary depending upon the implementation.

I. Sorting/Screening According to how Much Money is Risked Per Basis Point

As discussed, bets can be offered in which a bettor risks an amount of money per basis point of overperformance or underperformance.

For example, a bettor can bet $1,000 per basis point that his fund overperforms or underperforms. In this example, if his fund overperforms by 300 basis points, he will win $300,000; if the fund underperforms by 300 basis points, he will lose $300,000.

When this kind of bet offer is used, funds can be sorted and/or screened according to how much money is bet per basis point.

Accordingly, the invention can provide for a method (or apparatus) for sorting and/or screening funds according to the amount bet per basis point that the fund will overperform or underperform.

1. a method for using an online computer database to facilitate financial disclosure about companies comprising the steps of:
a user entering a bet offer about the financial condition of a company, said bet offer including an amount of money at risk, the name of a company, a bet statement containing the description of an objectively verifiable fact that will be known at some future date, and terms that define how the result of the bet is determined by the resolution of said fact,
said user entering whether he is an insider or not,
displaying the bet offer, including displaying whether the user making said offer is an insider or not,
said computer enabling said bet offer to be accepted by other users,
identifying whether a user, if any, accepting the offer is an insider or not,
displaying the bet acceptance, if any, including displaying whether the user making the accepting offer is an insider or not,
if said bet offer is accepted, settling said bet after said fact is resolved, displaying the result.

2. the method of claim 1, including the step of enabling a user who is an insider to enter his relationship to said company and displaying that relationship to other users.

3. the method of claim 1, including the step of enabling a user who is an insider to enter and control whether his name is secret or public in the display of said user's bet offer.

4. the method of claim 1, including a class of users that verifies whether users who enter bet offers are insiders, and including the step of enabling said class of users to enter verifications for display into said database system.

5. the method of claim 1, including a class of users that verifies whether users who enter bet offers are insiders, and verifies the relationship of insiders to their companies, and including the step of enabling said class of users to enter verifications for display into said database system.

6. the method of claim 1 in which said bet statement is about said company's earnings.

7. the method of claim 1 in which said bet statement is about whether said will go bankrupt.

8. the method of claim 1 in which said bet statement is about whether said company will default on a loan.

9. the method of claim 1 in which said bet statement is about said company's management's public estimates of financial performance.

10. the method of claim 1, including the steps of enabling a user who is an insider to enter his yearly compensation and net worth into a user profile, and using said compensation data to display how the amount he risks in said bet offer compares to his compensation.

11. the method of claim 1, including the steps of charging users who are not insiders to view bet offers by insiders, and paying insiders when their bet offers are viewed by users who are not insiders.
